(19) United States
(12) Patent Application Publication
(10) Pub. No.: US 2026/0279896 A1
(43) Pub. Date: Sep. 17, 2026

(54) SOLID ELECTROLYTE

(71) Applicants: TOYOTA JIDOSHA KABUSHIKI KAISHA, Toyota-shi Aichi-ken (JP); UNIVERSITY PUBLIC CORPORATION OSAKA, Osaka-shi Osaka (JP)

(72) Inventors: Azusa NAKANISHI, Susono-shi Shizuoka-ken (JP); Shinya SHIOTANI, Nagoya-shi Aichi-ken (JP); Akitoshi HAYASHI, Osaka-shi Osaka (JP); Kota MOTOHASHI, Sakai-shi Osaka (JP); Atsushi SAKUDA, Sakai-shi Osaka (JP)

(73) Assignees: TOYOTA JIDOSHA KABUSHIKI KAISHA, Toyota-shi Aichi-ken (JP); UNIVERSITY PUBLIC CORPORATION OSAKA, Osaka-shi Osaka (JP)

(21) Appl. No.: 19/558,642

(22) Filed: Mar. 6, 2026

(30) Foreign Application Priority Data
Mar. 11, 2025 (JP) 2025-037876

(51) Int. Cl. H01M 10/0562; H01M 10/0525

(52) U.S. Cl. CPC H01M 10/0562; H01M 10/0525; H01M 2300/0068

(57) ABSTRACT

A solid electrolyte, with a β-Li₃PS₄ crystal structure, and a composition formula expressed by Li₃₋₂ₓMgₓPS₄ (0.05≤x≤0.15). The solid electrolyte has a high Li ion conductivity.

### CROSS-REFERENCE TO RELATED APPLICATION

This application claims priority to Japanese Patent Application No. 2025-037876 filed on Mar. 11, 2025. The disclosure of the above-identified application, including the specification, drawings, and claims, is incorporated by reference herein in its entirety.

### BACKGROUND

### 1. Technical Field

The present disclosure relates to a solid electrolyte.

### 2. Description of Related Art

Various technologies have been proposed regarding a solid electrolyte, such as that disclosed in Japanese Unexamined Patent Application Publication No. 2016-62718 (JP 2016-62718 A).

### SUMMARY

Conventional solid electrolytes having a β—Li₃PS₄ crystal structure have low Li ion conductivity, because Li strongly interacts with PS₄ anions within the crystal structure, and there is room for improvement in Li ion conductivity.

The present disclosure has been made in light of the above circumstances, and a main object thereof is to provide a solid electrolyte having high Li ion conductivity.

That is to say, the present disclosure includes the following aspects.
<1> A solid electrolyte, with a β-Li₃PS₄ crystal structure, and a composition formula expressed by Li₃₋₂ₓMgₓPS₄ (0.05≤x≤0.15).
<2> The solid electrolyte according to <1>, in which, in a diffraction spectrum obtained by X-ray diffraction (XRD), a ratio Ia/Ib of maximum peak intensity Ia in a diffraction angle 2θ range of 17.2° to 17.8° to maximum peak intensity Ib in a diffraction angle 2θ range of 17.8° to 18.4° is 0.96 or more and 1.19 or less.
<3> A battery including a cathode layer containing a cathode active material, an anode layer containing an anode active material, and an electrolyte layer disposed between the cathode layer and the anode layer, in which
at least one of the cathode layer, the anode layer, and the electrolyte layer contains the solid electrolyte according to <1> or <2>.

The present disclosure is desirable in that a solid electrolyte with high Li ion conductivity can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows X-ray diffraction spectra of Li₃₋₂ₓMgₓPS₄ glass ceramics according to Examples 1 to 3 and Comparative Example 1; and

FIG. 2 is an enlarged view of the X-ray diffraction spectra of Li₃₋₂ₓMgₓPS₄ glass ceramics according to Examples 1 to 3 and Comparative Example 1, in which diffraction angle 2θ is in a range of 16.0° to 20.0°.

### DETAILED DESCRIPTION OF EMBODIMENTS

An embodiment according to the present disclosure will be described below. It should be noted that matters other than those mentioned in the present specification in particular, that are necessary to carry out the present disclosure (e.g., general configurations and production processes of a solid electrolyte that are not characteristic of the present disclosure), can be understood as design matters for those skilled in the art based on conventional technology in the art. The present disclosure may be carried out based on the content disclosed in the present specification and the common general technical knowledge in the art.

In the present disclosure, unless otherwise specified, average particle size of particles is the median diameter (D50) value, which is a particle size at an integrated value of 50% in volume-based particle size distribution measured by laser diffraction/scattering particle size distribution measurement.

### 1. Solid Electrolyte

The present disclosure provides a solid electrolyte having a β-Li₃PS₄ crystal structure and a composition formula expressed by Li₃₋₂ₓMgₓPS₄ (0.05≤x≤0.15).

Li₃PS₄ generally has four solid states, which are three types of crystal structures that vary depending on temperature (high-temperature stable phases that are α-phase, β-phase, and γ-phase), and a glass phase that is a thermodynamic non-equilibrium phase. β-phase Li₃PS₄ is easier to prepare as compared to α-phase Li₃PS₄ and has higher ionic conductivity than γ-phase Li₃PS₄.

According to the present disclosure, in a solid electrolyte having a β-Li₃PS₄ crystal structure, doping the Li site with Mg cations makes interaction between the Mg cations with a greater charge and PS₄ anions to become stronger, whereby the Li becomes more mobile and further improves the Li ion conductivity of the solid electrolyte.

The present disclosure provides a solid electrolyte (sulfide solid electrolyte) having a β-Li₃PS₄ crystal structure and a composition formula expressed by Li₃₋₂ₓMgₓPS₄ (0.05≤x≤0.15).

When x is less than 0.05, the amount of Mg that is doped is small, and the Li ion conductivity of the solid electrolyte decreases. When x exceeds 0.15, the amount of Mg that is doped increases, making it difficult to maintain the β-Li₃PS₄ crystal structure, and the Li ion conductivity of the solid electrolyte decreases.

The amount of substitution of Mg element may be within a range of 3.3% to 10%.

In a diffraction spectrum obtained by X-ray diffraction (XRD), a ratio Ia/Ib of maximum peak intensity Ia in the diffraction angle 2θ range of 17.2° to 17.8° to maximum peak intensity Ib in the diffraction angle 2θ range of 17.8° to 18.4° may be 0.96 or more and 1.19 or less.

When Ia/Ib is less than 0.96, the amount of Mg that is doped increases, resulting in a decrease in the Li ion conductivity of the solid electrolyte. When Ia/Ib exceeds 1.19, the amount of Mg that is doped decreases, resulting in a decrease in the Li ion conductivity of the solid electrolyte.

The form of the solid electrolyte according to the present disclosure is not limited in particular, but may be, for example, particulate. The solid electrolyte particles may have an average particle size (D50) of, for example, 0.1 μm to 50 μm.

The method for producing a solid electrolyte according to the present disclosure may include (1) a vitrification process and (2) a glass ceramic crystallization process.

### (1) Vitrification Process

In the vitrification process, the glass (sulfide glass) expressed by Li₃₋₂ₓMgₓPS₄ (0.05≤x≤0.15) may be obtained by bulk synthesis by mixing Li₂S, MgS, and P₂S₅ in a predetermined molar ratio.

Also, in the vitrification process, the glass expressed by Li₃₋₂ₓMgₓPS₄ (0.05≤x≤0.15) may be obtained by split synthesis in which, from the viewpoint of improving the reactivity of MgS, MgS and P₂S₅ are first mixed in a predetermined molar ratio to prepare an MgS—P₂S₅ composite, and then the MgS—P₂S₅ composite and Li₂S are mixed in a predetermined molar ratio.

The proportion of Li₂S with respect to the total of Li₂S, P₂S₅, and MgS may be, for example, 67.5 mol % or more and 72.5 mol % or less.

The proportion of MgS with respect to the total of Li₂S, P₂S₅, and MgS may be, for example, 2.5 mol % or more and 7.5 mol % or less.

The mixing method is not limited in particular, and examples thereof include mechanical milling and so forth. The mechanical milling may be dry mechanical milling or may be wet mechanical milling. Examples of mechanical milling include a ball mill, a vibration mill, a turbo mill, a mechanofusion mill, a disc mill, and so forth.

The various conditions for mechanical milling are set so as to enable the desired glass to be obtained. For example, when a planetary ball mill is used, treatment is performed in which a raw material composition and milling balls are placed in a container, and milled at a predetermined rotation speed for a predetermined amount of time. The rotation speed of the turntable is, for example, in a range of 200 rpm to 600 rpm, may be in a range of 400 to 600 rpm, and may be 510 rpm. Also, the treatment time when using a planetary ball mill may be, for example, 1 hour or more, or 10 hours or more, and 90 hours or less, or 40 hours or less.

Examples of materials for the container and milling balls used in planetary ball mills include ZrO₂ and Al₂O₃. The diameter of the milling balls is, for example, 1 mm or more and 20 mm or less. Mechanical milling may be performed in an inert gas atmosphere (e.g., an Ar gas atmosphere).

### (2) Glass Ceramic Crystallization Process

In the glass ceramic crystallization process, the glass may be fired at a predetermined temperature to obtain glass-ceramics expressed by Li₃₋₂ₓMgₓPS₄ (0.05≤x≤0.15) having a β-Li₃PS₄ crystal structure.

To obtain a β-Li₃PS₄ crystal structure, the firing temperature of the glass may be, for example, 230° C. or higher or 240° C. or higher, and may be 400° C. or lower.

The firing time of the glass may be, for example, 30 minutes or more, or 2 hours or more, and may be 4 hours or less.

### 2. Battery

The solid electrolyte of the present disclosure is for use in a battery.

The present disclosure provides a battery having a cathode layer containing a cathode active material, an anode layer containing an anode active material, and an electrolyte layer disposed between the cathode layer and the anode layer.

A battery is provided in which at least one of the cathode layer, the anode layer, and the electrolyte layer contains the solid electrolyte according to the present disclosure.

Batteries have a cathode layer, an electrolyte layer, and an anode layer, and typically have a cathode, an electrolyte layer, and an anode.

The solid electrolyte according to the present disclosure may be contained in at least one type selected from a group consisting of a cathode layer, an electrolyte layer, and an anode layer, of a battery. Also, the solid electrolyte according to the present disclosure may be contained in at least the electrolyte layer, and may further be contained in at least one of the cathode layer and the anode layer.

### Cathode

The cathode has a cathode layer, and further has a cathode current collector as necessary.

The cathode layer contains a cathode active material, and may contain the solid electrolyte according to the present disclosure, a conductive material, a binder, and the like, as necessary.

The thickness of the cathode layer may be, for example, 0.1 μm or more and 1000 μm or less.

The cathode active material is not limited in particular, but examples thereof can include layered rock-salt active materials such as LiCoO₂, LiMnO₂, LiNiO₂, LiVO₂, LiNi_{1/3}Co_{1/3}Mn_{1/3}O₂, and so forth, spinel active materials such as LiMn₂O₄, Li(Ni_{0.5}Mn_{1.5})O₄, and so forth, and olivine active materials such as LiFePO₄, LiMnPO₄, LiNiPO₄, and LiCuPO₄ and so forth. Alternatively, Si-containing oxides such as Li₂FeSiO₄, Li₂MnSiO₄, and so forth, may be used as the cathode active material.

Examples of conductive materials include carbon materials, metal particles, and electrically conductive polymers. Examples of carbon materials include particulate carbon materials such as acetylene black (AB) Ketjen black (KB), and so forth, and fibrous carbon materials such as vapor-grown carbon fibers (VGCFs), carbon nanotubes (CNTs), carbon nanofibers (CNFs), and so forth.

The proportion of the conductive material in the cathode layer may be, for example, 0.1% by mass or more and 1.0% by mass or more.

The cathode layer may contain a binder. Examples of binders include styrene-butadiene rubber (SBR), acrylonitrile-butadiene rubber (NBR), butadiene rubber (BR), polyvinylidene fluoride (PVDF), polytetrafluoroethylene (PTFE), styrene-isoprene-styrene block copolymers (SISs), ethylene-propylene-diene copolymers (EPDMs), and so forth.

The proportion of the binder in the cathode layer may be, for example, 0.5% by mass or more and 5% by mass or less.

Examples of materials for the cathode current collector include SUS, Cr, Au, Pt, Zn, aluminum, copper, nickel, iron, titanium, carbon, and so forth. The thickness of the cathode current collector is, for example, 0.1 μm or more and 100 μm or less. The cathode current collector may be in the form of a foil, a plate, or the like. The cathode current collector may have a configuration in which a buffer layer, an elastic layer, or a positive temperature coefficient (PTC) thermistor layer is disposed on the surface thereof

### Anode

An anode includes an anode layer, and further includes an anode current collector as necessary.

The anode layer includes an anode active material, and may contain the solid electrolyte according to the present disclosure, a conductive material, a binder, and so forth, as necessary.

Examples of the anode active material include a Li-based active material, a carbon active material, and so forth.

Examples of Li-based active materials include elemental Li, Li alloys, and so forth. Examples of metal elements other than lithium contained in Li alloys include Mg, Ag, In, Sn, Si, Ga, Au, Pt, and so forth.

Examples of the carbon active material can include mesocarbon microbeads (MCMB), highly oriented pyrolytic graphite (HOPG), hard carbon, soft carbon, and so forth.

The conductive material and the binder used in the anode layer are the same as the content thereof described above for the cathode layer, and accordingly will not be described here. The thickness of the anode layer may be, for example, in a range of 0.1 μm to 1000 μm.

Examples of materials for the anode current collector include stainless steel, aluminum, copper, nickel, iron, titanium, carbon, and so forth. The anode current collector may be in the form of a foil, a plate, or the like. Also, the thickness of the anode current collector may be, for example, in a range of 1 μm to 50 μm. The anode current collector may have a configuration in which a buffer layer, an elastic layer, or a PTC thermistor layer is disposed on the surface thereof.

### Electrolyte Layer

The electrolyte layer is a layer that is formed between the cathode layer and the anode layer, and contains at least an electrolyte. The electrolyte may be a solid electrolyte. The electrolyte layer may be a solid electrolyte layer containing a solid electrolyte.

The solid electrolyte may be the solid electrolyte according to the present disclosure. The content of the solid electrolyte of the present disclosure in the solid electrolyte layer is, for example, in a range of 10% by volume to 100% by volume, and may be in a range of 50% by volume to 100% by volume. In the present disclosure, the solid electrolyte layer may be made solely of the solid electrolyte according to the present disclosure. On the other hand, when the cathode layer or the anode layer uses the above-described solid electrolyte according to the present disclosure, any solid electrolyte material can be used for the solid electrolyte layer.

When the electrolyte layer is a solid electrolyte layer, the solid electrolyte layer contains a solid electrolyte, and also includes a binder and the like as necessary.

Examples of the binder can include the binders that can be contained in the cathode layer described above.

When the solid electrolyte layer contains a binder, the content of the binder may be 0% by mass to 10% by mass with respect to the total amount of the solid electrolyte layer.

The thickness of the electrolyte layer may be, for example, 0.1 μm or more and 1000 μm or less.

The battery according to the present disclosure may further include a constraining jig that applies a constraining pressure along a thickness direction to the cathode layer, the electrolyte layer, and the anode layer. In particular, when the electrolyte layer is a solid electrolyte layer, the constraining pressure may be applied to form ion conduction paths and electron conduction paths that are satisfactory. The constraining pressure is, for example, 0.1 MPa or more, and may be 1 MPa or more, or 5 MPa or more. On the other hand, the constraining pressure is, for example, 100 MPa or less, and may be 50 MPa or less, or 20 MPa or less.

The type of the battery in the present disclosure is not limited in particular, but is typically a lithium-ion battery. Also, the battery according to the present disclosure may be a liquid battery in which the electrolyte layer contains an electrolytic solution, or may be a solid-state battery in which the electrolyte layer contains a solid electrolyte. The solid-state battery may be a semi-solid-state battery or an all-solid-state battery. In the present disclosure, a semi-solid-state battery is a battery in which the electrolyte layer has a solid component, such as a solid electrolyte or the like, and a liquid component (e.g., an ionic liquid). In the present disclosure, an all-solid-state battery is a battery in which the electrolyte layer has only solid components, such as a solid electrolyte or the like, as the electrolyte. Also, the battery according to the present disclosure may be either a primary battery or a secondary battery, but in particular may be a secondary battery. This is because it can be repeatedly charged and discharged, and accordingly is useful as an in-vehicle battery, for example.

The shape of the battery is not limited in particular, and may be a coin battery, a cylindrical battery, a prismatic battery, a sheet battery, a button battery, a flat battery, or a laminated battery, for example.

Examples of applications of the battery include power sources for vehicles such as hybrid electric vehicles (HEVs), plug-in hybrid electric vehicles (PHEVs), battery electric vehicles (BEVs), gasoline automobiles, diesel automobiles, and so forth. In particular, the battery may be used as a drive power source for hybrid electric vehicles (HEVs), plug-in hybrid electric vehicles (PHEV), or battery electric vehicles (BEVs). The battery may also be used as a power source for moving objects other than vehicles (e.g., trains, ships, and aircraft), or may be used as a power source for electrical products such as information processing devices and so forth.

Note that the present disclosure is not limited to the above embodiment. The above embodiment is merely exemplary, and any structure having substantially the same configuration as, and having similar functions and effects to, the technical idea described in the claims of the present disclosure is encompassed by the technical scope of the present disclosure.

### Comparative Example 1

### Synthesis of Li₃PS₄ (x=0) Glass

A total of 1.0 g of Li₂S and P₂S₅ were weighed out at a molar ratio was 3:1, and placed in a 45 mL pot made of ZrO₂. After adding 90 g of 4-mm diameter ZrO₂ balls thereto, the mixture was sealed and was mixed in a planetary ball mill at a rotation speed of 510 rpm for 40 hours to obtain Li₃PS₄ (x=0) glass.

### Preparation of Li₃PS₄ (x=0) Glass Ceramic

The Li₃PS₄ (x=0) glass that was obtained was weighed out in an amount of 150 mg and uniaxially pressed at 360 MPa for 5 minutes using a 10-mm diameter pellet molding jig to obtain pellets. The pellets that were obtained were fired in an electric furnace in an Ar glove box at 240° C. for 2 hours to obtain a Li₃PS₄ (x=0) glass ceramic.

### Examples 1 to 3, Comparative Example 2

### Preparation of MgS—P₂S₅ Composite (Split Synthesis)

MgS manufactured by Japan Pure Chemical Co., Ltd. and P₂S₅ manufactured by Sigma-Aldrich were weighed out in a predetermined molar ratio to make a total of 1.0 g, and placed in a 45 mL pot made of ZrO₂. After adding 90 g of 4 mm diameter ZrO₂ balls, the mixture was sealed and mixed in a planetary ball mill at a rotation speed of 510 rpm for 90 hours to obtain a MgS—P₂S₅ composite.

### Preparation of Li₃₋₂ₓMgₓPS₄ Glass (Split Synthesis)

The MgS—P₂S₅ composite that was synthesized, and Li₂S manufactured by Mitsuwa Chemical Co., Ltd. were weighed out in a predetermined molar ratio to make a total of 1.0 g, and placed in a 45 mL pot made of ZrO₂. After adding 90 g of 4-mm diameter ZrO₂ balls thereto, the mixture was sealed and was mixed in a planetary ball mill at a rotation speed of 510 rpm for 10 hours to obtain Li₃₋₂ₓMgₓPS₄ glass.

In Example 1, Li_{2.9}Mg_{0.05}PS₄ (x=0.05) glass was obtained.

In Example 2, Li_{2.8}Mg_{0.10}PS₄ (x=0.10) glass was obtained.

In Example 3, Li_{2.7}Mg_{0.15}PS₄ (x=0.15) glass was obtained.

In Comparative Example 2, Li_{2.4}Mg_{0.30}PS₄ (x=0.30) glass was obtained.

Table 1 shows the amounts (mol %) of Li₂S, MgS, and P₂S₅ used as raw materials for obtaining the Li₃₋₂ₓMgₓPS₄ in Examples 1 to 3 and Comparative Examples 1 and 2.

### Preparation of Li₃₋₂ₓMgₓPS₄ Glass Ceramics

Next, 150 mg in weight of the Li₃₋₂ₓMgₓPS₄ glass obtained in each of Examples 1 to 3 and Comparative Examples 1 and 2 were weighed out and uniaxially pressed at 360 MPa for 5 minutes using a 10-mm diameter pellet molding jig to obtain pellets. The pellets that were obtained were fired in an electric furnace in an Ar glove box at 240° C. for 2 hours to obtain Li₃₋₂ₓMgₓPS₄ glass ceramics.

### XRD Measurement

X-ray diffraction data was acquired for the Li₃₋₂ₓMgₓPS₄ glass ceramics of Examples 1 to 3 and Comparative Examples 1 and 2 using an X-ray diffractometer (Rigaku Corporation, SmartLab) under the conditions of a Cu-Kα radiation source, a tube voltage of 45 kV, a tube current of 200 mA, a sampling width of 0.02°, and a scan rate of 5°/min.

With regard to the X-ray diffraction data that was obtained, a baseline was drawn between diffraction angles 2θ of 17.0° and 19.0°, and a value obtained by subtracting the baseline intensity from the maximum value of peak intensity at diffraction angles 2θ of 17.2° to 17.8° was designated as Ia, and a value obtained by subtracting the baseline intensity from the maximum value of peak intensity at diffraction angles 2θ of 17.8° to 18.4° was designated as Ib.

### Ia/Ib

Intensity ratios (Ia/Ib) of the Li₃₋₂ₓMgₓPS₄ glass ceramics of Examples 1 to 3 and Comparative Examples 1 and 2 were calculated. The results are shown in Table 1.

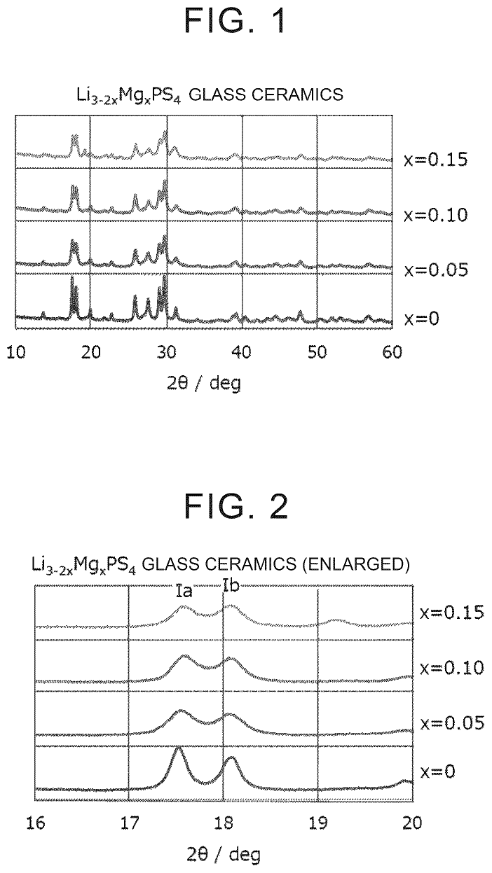

FIG. 1 shows X-ray diffraction spectra of Li₃₋₂ₓMgₓPS₄ glass ceramics according to Examples 1 to 3 and Comparative Example 1.

FIG. 2 is an enlarged view of the X-ray diffraction spectra of Li₃₋₂ₓMgₓPS₄ glass ceramics according to Examples 1 to 3 and Comparative Example 1, in which diffraction angle 2θ is in a range of 16.0° to 20.0°.

### Crystal Structures

The Li₃₋₂ₓMgₓPS₄ glass ceramics obtained in Examples 1 to 3 and Comparative Examples 1 and 2 had peaks at diffraction angles 2θ between 17.2° and 17.8° and had peaks at diffraction angles 2θ between 17.8° and 18.4°, and were therefore confirmed to have a β-Li₃PS₄ crystal structure.

### Li Ion Conductivity

The Li ion conductivity of the Li₃₋₂ₓMgₓPS₄ glass ceramics of Examples 1 to 3 and Comparative Examples 1 and 2 was measured by the alternating current impedance method. The results are shown in Table 1.

TABLE 1

| | | | | | | Ionic |
|---|---|---|---|---|---|---|
| | | | | | | conduc- |
| | X | Li₂S | MgS | P₂S₅ | Ia/Ib | tivity |
| | — | mol % | mol % | mol % | — | S/cm |
| Comparative | 0 | 75.0 | 0 | 25.0 | 1.29 | 2.3 × 10⁻⁴ |
| Example 1 | | | | | | |
| Example 1 | 0.05 | 72.5 | 2.5 | 25.0 | 1.19 | 2.6 × 10⁻⁴ |
| Example 2 | 0.10 | 70.0 | 5.0 | 25.0 | 1.07 | 4.2 × 10⁻⁴ |
| Example 3 | 0.15 | 67.5 | 7.5 | 25.0 | 0.96 | 2.9 × 10⁻⁴ |
| Comparative | 0.3 | 60.0 | 15.0 | 25.0 | 0.36 | 7.3 × 10⁻⁵ |
| Example 2 | | | | | | |

### Evaluation Results

As shown in Table 1, the solid electrolytes of Examples 1 to 3, which are represented by Li₃₋₂ₓMgₓPS₄ (0.05≤x≤0.15), were confirmed to have higher Li ion conductivity than the solid electrolytes of Comparative Examples 1 and 2, which fell outside this range. Accordingly, it can be understood that in a solid electrolyte having a β-Li₃PS₄ crystal structure, the Li ion conductivity of the solid electrolyte can be improved by doping the Li site with a predetermined amount of Mg cations.

What is claimed is:

1. A solid electrolyte, with a β-Li₃PS₄ crystal structure, and a composition formula expressed by Li₃₋₂ₓMgₓPS₄ (0.05≤x≤0.15).

2. The solid electrolyte according to claim 1, wherein, in a diffraction spectrum obtained by X-ray diffraction (XRD), a ratio of maximum peak intensity in a diffraction angle range of 17.2° to 17.8° to maximum peak intensity in a diffraction angle range of 17.8° to 18.4° is 0.96 or more and 1.19 or less.

3. A battery comprising:
a cathode layer containing a cathode active material;
an anode layer containing an anode active material; and
an electrolyte layer disposed between the cathode layer and the anode layer, wherein at least one of the cathode layer, the anode layer, and the electrolyte layer contains the solid electrolyte according to claim 1.
